(19) United States
(12) Patent Application Publication
(10) Pub. No.: US 2013/0244108 A1
(43) Pub. Date: Sep. 19, 2013

(54) Total Solid Battery and Method of Producing the Same

(71) Applicant: MURATA MANUFACTURING CO., LTD., NAGAOKAKYO-SHI (JP)

(72) Inventors: Takeshi Hayashi, Nagaokakyo-Shi (JP); Makoto Yoshioka, Nagaokakyo-Shi (JP); Masutaka Ouchi, Nagaokakyo-Shi (JP); Kunio Nishida, Kyoto-Fu (JP)

(73) Assignee: MURATA MANUFACTURING CO., LTD., NAGAOKAKYO-SHI (JP)

(21) Appl. No.: 13/874,587

(22) Filed: May 1, 2013

Related U.S. Application Data
(63) Continuation of application No. PCT/JP2011/075138, filed on Nov. 1, 2011.

(30) Foreign Application Priority Data
Nov. 4, 2010 (JP) 2010-247102

(51) Int. Cl. H01M 10/0585

(52) U.S. Cl. CPC H01M 10/0585
USPC 429/211; 29/623.1; 29/623.5

(57) ABSTRACT

A method of producing a total solid battery by stacking a molded body of each of a positive electrode material, a solid electrolyte material, a negative electrode material, and a collector material and firing the stacked body. The firing step includes a first firing step of firing the stacked body in an inert atmosphere and, after the first firing step, a second firing step of firing the stacked body in an atmosphere containing oxygen.

### CROSS REFERENCE TO RELATED APPLICATIONS

The present application is a continuation of International application No. PCT/JP2011/075138, filed Nov. 1, 2011, which claims priority to Japanese Patent Application No. 2010-247102, filed Nov. 4, 2010, the entire contents of each of which are incorporated herein by reference.

### FIELD OF THE INVENTION

The present invention relates to a total solid battery and to a method of producing the same.

### BACKGROUND OF THE INVENTION

In recent years, there is a considerably increasing demand for a battery as a power source of a portable electronic apparatus such as a portable telephone or a portable personal computer. In a battery used for such purposes, an electrolyte (electrolytic solution) such as an organic solvent is conventionally used as a medium for transporting ions.

However, in the battery having a construction described above, there is a danger of leakage of the electrolytic solution. Also, the organic solvent or the like used in the electrolytic solution is a combustible substance. For this reason, it is demanded to enhance the safety of the battery to a further extent.

Thus, as one measure for enhancing the safety of the battery, use of a solid electrolyte is proposed instead of the electrolytic solution, as the electrolyte. Further, development of a total solid battery in which a solid electrolyte is used as the electrolyte and the other constituent elements are also constituted of solids is being advanced.

For example, Japanese Patent Application Laid-open (JP-A) No. 2007-227362 Gazette (hereafter referred to as patent document 1) proposes a method of producing a total solid battery in which all the constituent elements are constituted of solids using a non-combustible solid electrolyte. The method of producing a total solid battery disclosed in the patent document 1 includes a heating step of heating a group of green sheets of a solid electrolyte, an active substance, and a collector at 200° C. or higher and 400° C. or lower in an oxidizing atmosphere and a firing step of firing the group of green sheets, which have been heated in the aforesaid heating step, in a low-oxygen atmosphere at a firing temperature higher than the heating temperature of the aforesaid heating step, thereby to obtain a stacked body including a solid electrolyte layer, an active substance layer, and a collector layer.

Patent document 1: Japanese Patent Application Laid-open (JP-A) No. 2007-227362 Gazette

### SUMMARY OF THE INVENTION

However, as a result of various studies made by the inventors and others on the method of producing a total solid battery such as disclosed in the patent document 1, it has been found out that, when a group of green sheets are heated in an oxidizing atmosphere, the collector layer is oxidized, so that the electron conductivity decreases, leading to deterioration in the battery characteristics. The present invention has been made based on the above knowledge.

Therefore, an object of the present invention is to provide a method of producing a total solid battery capable of suppressing oxidation of the collector layer and a total solid battery produced by the method.

As a result of various studies made by the inventors and others in order to solve the aforementioned problems, it has been found that the oxidation of the collector layer can be suppressed by firing the group of green sheets including the collector in an inert atmosphere and thereafter further firing the group of green sheets in an atmosphere containing oxygen. Based on such a knowledge of the inventors and others, the present invention has the following characteristics.

The method of producing a total solid battery according to the present invention is a method of producing a total solid battery each of which is provided with a positive electrode layer, a solid electrolyte layer, a negative electrode layer, and a collector layer disposed on at least one of the positive electrode layer or the negative electrode layer, which are sequentially stacked, and includes the following steps:

(A) a stacked body forming step of forming a stacked body by stacking a molded body of each of a positive electrode material, a solid electrolyte material, a negative electrode material, and a collector material

(B) a firing step of firing the aforesaid stacked body

(C) the aforesaid firing step includes a first firing step of firing the stacked body in an inert atmosphere and a second firing step of firing the stacked body in an atmosphere containing oxygen after the first firing step.

In the method of producing a total solid battery of the present invention, the first firing step preferably includes heating the stacked body at a temperature of 600° C. or below.

Also, in the method of producing a total solid battery of the present invention, the second firing step preferably includes heating the stacked body at a temperature of 200° C. or above and 700° C. or below.

Further, in the method of producing a total solid battery of the present invention, an oxygen content in the atmosphere in the second firing step is preferably more than 0 vol % and 20 vol % or less.

Furthermore, in the method of producing a total solid battery of the present invention, the oxygen content in the atmosphere in the second firing step is preferably 0.5 vol % or more and 5 vol % or less.

In the method of producing a total solid battery of the present invention, the stacked body forming step preferably includes forming the stacked body by stacking a green sheet of each of the positive electrode material, the solid electrolyte material, the negative electrode material, and the collector material.

In the method of producing a total solid battery of the present invention, at least one material among the positive electrode material, the solid electrolyte material, and the negative electrode material preferably contains a solid electrolyte made of a lithium-containing phosphoric acid compound having a NASICON-type structure.

In the method of producing a total solid battery of the present invention, at least one material among the positive electrode material and the negative electrode material preferably contains an electrode active substance made of a lithium-containing phosphoric acid compound.

The total solid battery according to the present invention is produced by a production method having the above-described characteristics.

According to the method of producing a total solid battery of the present invention, the oxidation of the collector layer can be suppressed by firing the stacked body including the molded body of the collector material in an inert atmosphere and thereafter firing the stacked body in an atmosphere containing oxygen, so that the deterioration in the battery characteristics can be prevented.

### BRIEF EXPLANATION OF THE DRAWINGS

FIG. 1 is a cross-sectional model view showing a cross-sectional structure of a total solid battery as one embodiment to which the production method of the present invention is applied.

FIG. 2 is a cross-sectional model view showing a cross-sectional structure of a total solid battery as another embodiment to which the production method of the present invention is applied.

FIG. 3 is a cross-sectional model view showing a cross-sectional structure of a total solid battery as still another embodiment to which the production method of the present invention is applied.

FIG. 4 is a cross-sectional model view showing a cross-sectional structure of a stacked body constituting a part of the total solid battery fabricated in an Example of the present invention.

FIG. 5 is a cross-sectional model view showing a cross-sectional structure of a total solid battery fabricated in an Example of the present invention.

FIG. 6 is a view showing a relationship between the discharge capacity of a total solid battery fabricated in an Example of the present invention and the oxygen content in an atmosphere in which the second firing step was carried out.

### DETAILED DESCRIPTION OF THE INVENTION

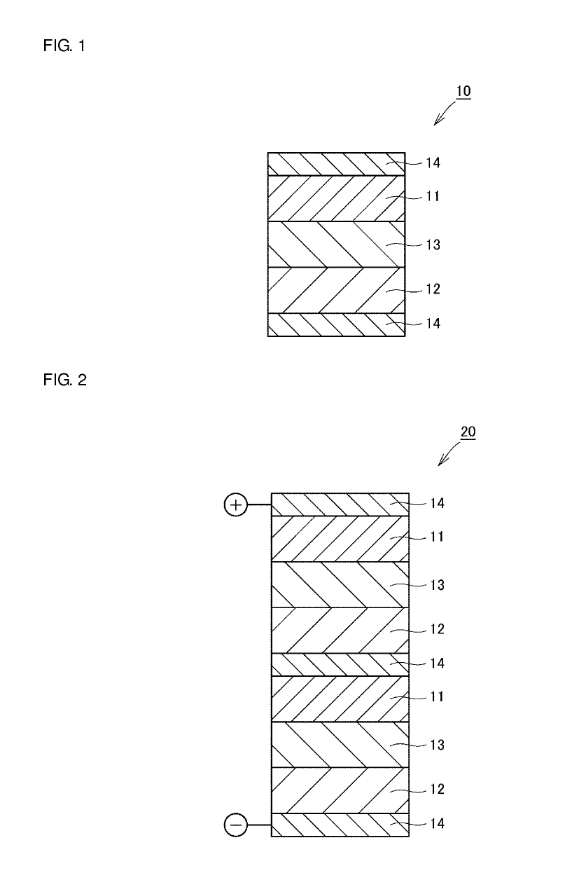

As illustrated in FIG. 1, a total solid battery stacked body 10 as one embodiment to which the production method of the present invention is applied is constituted of a unit cell made of a positive electrode layer 11, a solid electrolyte layer 13, a negative electrode layer 12, and a collector layer 14. The positive electrode layer 11 is disposed on one surface of the solid electrolyte layer 13, and the negative electrode layer 12 is disposed on the other surface of the solid electrolyte layer 13 that is opposite to the one surface. In other words, the positive electrode layer 11 and the negative electrode layer 12 are disposed at positions that face each other through the intermediary of the solid electrolyte layer 13. The collector layer 14 is disposed on a surface of the positive electrode layer 11 that is not in contact with the solid electrolyte layer 13, and the collector layer 14 is disposed on a surface of the negative electrode layer 12 that is not in contact with the solid electrolyte layer 13.

As illustrated in FIG. 2, in a total solid battery stacked body 20 as another embodiment to which the production method of the present invention is applied, a plurality of pieces, for example, two pieces, of unit cells, each of which is constituted of a positive electrode layer 11, a solid electrolyte layer 13, and a negative electrode layer 12, are connected in series through the intermediary of a collector layer 14. The collector layer 14 that is disposed in the inside of the total solid battery stacked body 20 is provided between the positive electrode layer 11 and the negative electrode layer 12. On the outside of the total solid battery stacked body 20, the collector layer 14 is disposed on a surface that is not in contact with the solid electrolyte layer 13 among the surfaces of the positive electrode layer 11 located at the outermost layer, and the collector layer 14 is disposed on a surface that is not in contact with the solid electrolyte layer 13 among the surfaces of the negative electrode layer 12 located at the outermost layer. A positive electrode terminal is connected to the collector layer 14 that is in contact with the positive electrode layer 11 located at the outermost layer, and a negative electrode terminal is connected to the collector layer 14 that is in contact with the negative electrode layer 12 located at the outermost layer.

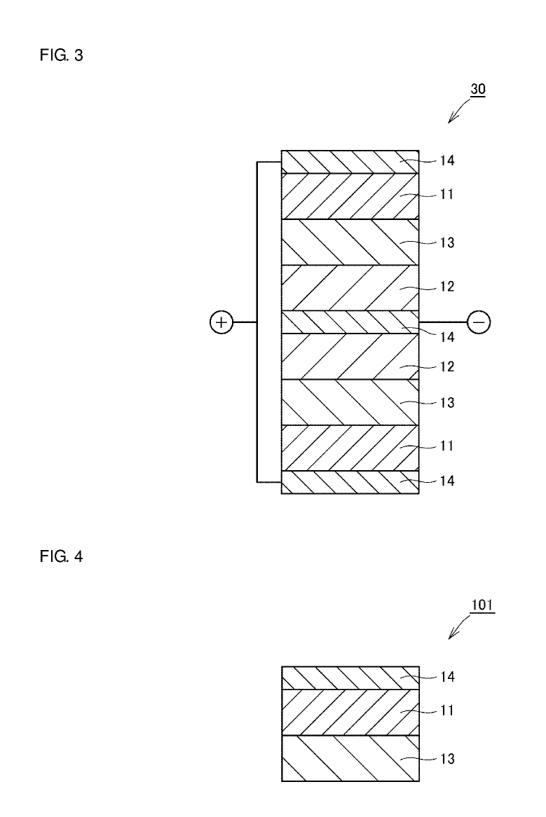

As illustrated in FIG. 3, in a total solid battery stacked body 30 as still another embodiment to which the production method of the present invention is applied, a plurality of pieces, for example, two pieces, of unit cells, each of which is constituted of a positive electrode layer 11, a solid electrolyte layer 13, and a negative electrode layer 12, are connected in parallel through the intermediary of a collector layer 14. The collector layer 14 that is disposed in the inside of the total solid battery stacked body 30 is provided between the negative electrode layer 12 and the negative electrode layer 12 (or between the positive electrode layer 11 and the positive electrode layer 11). On the outside of the total solid battery stacked body 20, the collector layer 14 is disposed on a surface that is not in contact with the solid electrolyte layer 13 among the surfaces of the positive electrode layer 11 (or the surfaces of the negative electrode layer 12) located at the outermost layer. A positive electrode terminal (or a negative electrode terminal) is connected to the collector layer 14 that is in contact with the positive electrode layer 11 (or the negative electrode layer 12) located at the outermost layer, and a negative electrode terminal (or a positive electrode terminal) is connected to the collector layer 14 that is in contact with the negative electrode layer 12 (or the positive electrode layer 11) located in the inside.

Here, each of the positive electrode layer 11 and the negative electrode layer 12 contains a solid electrolyte and an electrode active substance, and the solid electrolyte layer 13 contains a solid electrolyte. Each of the positive electrode layer 11 and the negative electrode layer 12 may contain carbon, metal, or the like as an electron-conductive material.

In the present invention, in order to produce a total solid battery stacked body 10, 20, 30 constructed in the above-described manner, a stacked body is formed by first stacking a molded body of each of a positive electrode material, a solid electrolyte material, a negative electrode material, and a collector material (stacked body forming step). Thereafter, the above stacked body is fired (firing step). This firing step includes a first firing step of firing the stacked body in an inert atmosphere and a second firing step of firing the stacked body in an atmosphere containing oxygen after the first firing step. In this manner, the oxidation of the collector layer can be suppressed by firing the stacked body including the molded body of the collector material in an inert atmosphere and thereafter firing the stacked body in an atmosphere containing oxygen, so that the deterioration in the battery characteristics can be prevented. In the first firing step, the binder can be decomposed by self-combustion action of the binder. In the second firing step, the residual carbon generated in the first firing step can be removed with use of a slight amount of oxygen.

The first firing step preferably includes heating the stacked body at a temperature of 600° C. or below. Also, the second firing step preferably includes heating the stacked body at a temperature of 200° C. or above and 700° C. or below. In this manner, the effect of suppressing the oxidation of the collector layer can be further improved by controlling the firing temperature (first firing temperature) of the first firing step and the firing temperature (second firing temperature) of the second firing step. Here, the first firing temperature may be either lower or higher than the second firing temperature, or else the first firing temperature and the second firing temperature may be the same temperature. The first firing temperature is preferably 100° C. or higher.

The inert atmosphere in the first firing step is preferably an atmosphere substituted with nitrogen gas in view of productivity; however, the inert atmosphere may be an atmosphere substituted with argon gas or a reducing atmosphere mingled with hydrogen gas. Also, the carrier gas in the second firing step is preferably an atmosphere substituted with nitrogen gas in view of productivity; however, the carrier gas may be an atmosphere substituted with argon gas.

Further, in the method of producing a total solid battery according to the present invention, the oxygen content in the atmosphere in the second firing step is preferably more than 0 vol % and 20 vol % or less. In this manner, the oxidation of the collector layer can be effectively prevented by controlling the oxygen content in the firing atmosphere.

Furthermore, in the method of producing a total solid battery according to the present invention, the oxygen content in the atmosphere in the second firing step is preferably 0.5 vol % or more and 5 vol % or less. In this manner, a total solid battery stacked body 10, 20, 30 made of a dense stacked body can be obtained by controlling the oxygen content in the firing atmosphere to be within a range of a slight amount.

In the method of producing a total solid battery according to the present invention, the stacked body forming step preferably includes forming the stacked body by stacking a green sheet of each of the positive electrode material, the solid electrolyte material, the negative electrode material, and the collector material. By firing the stacked body of the green sheets obtained in this manner, a total solid battery stacked body 10, 20, 30 serving as a power generating element of the total solid battery can be easily fabricated.

The method for molding the above green sheets is not particularly limited; however, a die-coater, a comma-coater, screen printing, or the like can be used. The method for stacking the green sheets is not particularly limited; however, the green sheets may be stacked by hot isostatic pressing (HIP), cold isostatic pressing (CIP), warm isostatic pressing (WIP), or the like.

Here, the kind of the electrode active substance contained in the positive electrode layer 11 or the negative electrode layer 12 of the total solid battery stacked body 10, 20, 30 to which the production method of the present invention is applied is not limited. However, as the positive electrode active substance, a lithium-containing phosphoric acid compound having a NASICON-type structure such as Li₃V₂(PO₄)₃, a lithium-containing phosphoric acid compound having an olivine-type structure such as LiFePO₄ or LiMnPO₄, a layered compound such as LiCoO₂ or LiCo_{1/3}Ni_{1/3}Mn_{1/3}O₂, a lithium-containing compound having a spinel-type structure such as LiMn₂O₄ or LiNi_{0.5}Mn_{1.5}O₄ can be used.

As the negative electrode active substance, a compound having a composition represented by MOₓ (M is at least one kind of an element selected from the group consisting of Ti, Si, Sn, Cr, Fe, and Mo, and x is a numerical value within a range of 0.9≦x≦2.0) can be used. For example, a mixture in which two or more active substances having a composition represented by MOₓ containing different elements M such as TiO₂ and SiO₂ are mixed can be used. Also, as the negative electrode active substance, a graphite-lithium compound, a lithium alloy such as Li-Al, Li₃V₂(PO₄)₃, Li₃Fe₂(PO₄)₃, oxide such as Li₄Ti₅O₁₂, or the like can be used. a) Also, the kind of the solid electrolyte contained in the positive electrode layer 11, the negative electrode layer 12, or the solid electrolyte layer 13 of the total solid battery stacked body 10, 20, 30 to which the production method of the present invention is applied is not limited. However, as the solid electrolyte, a lithium-containing phosphoric acid compound having a NASICON-type structure can be used. The lithium-containing phosphoric acid compound having a NASICON-type structure is represented by the chemical formula LiₓM_{y}(PO₄)₃ (in the chemical formula, x satisfies 1≦x≦2; y satisfies 1≦y≦2; and M is one or more kinds of elements selected from the group consisting of Ti, Ge, Al, Ga, and Zr). In this case, part of P may be substituted with B, Si, or the like in the aforementioned chemical formula. For example, a mixture in which compounds having two or more different compositions of the lithium-containing phosphoric acid compounds having a NASICON-type structure, such as Li_{1.5}Al_{0.5}Ge_{1.5}(PO₄)₃ and Li_{1.2}Al_{0.2}Ti_{1.8}(PO₄)₃, are mixed may be used.

Also, as the lithium-containing phosphoric acid compound having a NASICON-type structure used in the above solid electrolyte, a compound containing a crystal phase of a lithium-containing phosphoric acid compound having a NASICON-type structure or glass that deposits a crystal phase of a lithium-containing phosphoric acid compound having a NASICON-type structure by heat treatment may be used.

Here, as a material used in the solid electrolyte described above, a material having an ion conductivity and having an electron conductivity so small as to be negligible can be used instead of a lithium-containing phosphoric acid compound having a NASICON-type structure. As such materials, lithium halide, lithium nitride, lithium oxygen acid salt, and derivatives thereof can be raised as examples. Also, Li-P-O series compounds such as lithium phosphate (Li₃PO₄), LIPON (LiPO₄₋ₓNₓ) obtained by mixing nitrogen with lithium phosphate, Li-Si-O series compounds such as Li₄SiO₄, Li-P-Si-O series compounds, Li-V-Si-O series compounds, compounds having a Perovskite-type structure such as La_{0.51}Li_{0.35}TiO^{2.94}, La_{0.55}Li_{0.35}TiO₃, and Li₃ₓLa_{2/3-x}TiO₃, compounds having a garnet type structure having Li, La, and Zr, and others can be raised as examples.

It is preferable that at least one material among the positive electrode material, the solid electrolyte material, and the negative electrode material of the total solid battery stacked body 10, 20, 30 to which the production method of the present invention is applied contains a solid electrolyte made of a lithium-containing phosphoric acid compound having a NASICON-type structure. In this case, a high ion conductivity that will be essential in the battery operation of the total solid battery can be obtained. Also, when glass or glass ceramics having a composition of a lithium-containing phosphoric acid compound having a NASICON-type structure is used as the solid electrolyte, a more dense sintered body can be easily obtained due to the viscous flow of the glass phase in the firing step, so that it is particularly preferable to prepare a starting source material of the solid electrolyte in a form of glass or glass ceramics.

Also, it is preferable that at least one material among the positive electrode material and the negative electrode material of the total solid battery stacked body 10, 20, 30 to which the production method of the present invention is applied contains an electrode active substance made of a lithium-containing phosphoric acid compound. In this case, phase change of the electrode active substance or reaction of the electrode active substance with the solid electrolyte in the firing step can be easily suppressed by a high temperature stability of the phosphoric acid skeleton, so that the capacity of the total solid battery can be increased. Also, when an electrode active substance made of a lithium-containing phosphoric acid compound and a solid electrolyte made of a lithium-containing phosphoric acid compound having a NASICON-type structure are used in combination, reaction of the electrode active substance with the solid electrolyte in the firing step can be suppressed, and a good contact of the two can be obtained, so that it is particularly preferable to use the materials of the electrode active substance and the solid electrolyte in combination as described above.

Further, the collector layer 14 of the total solid battery stacked body 10, 20, 30 to which the production method of the present invention is applied contains an electron-conductive material. The electron-conductive material preferably contains at least one kind selected from the group consisting of electron-conductive oxide, metal, and carbon material.

Next, an Example of the present invention will be specifically described. Here, the Example shown below is one example, so that the present invention is not limited to the Example described below.

### EXAMPLES

Hereafter, one Example of a total solid battery fabricated in accordance with the production method of the present invention will be described.

Li₃V₂(PO₄)₃ (hereafter referred to as LVP) as a lithium-containing phosphoric acid compound having a NASICON-type structure was used as an electrode active substance; a glass powder Li_{1.5}Al_{0.5}Ge_{1.5}(PO₄)₃ (hereafter referred to as LAGP) having a composition of a lithium-containing phosphoric acid compound having a NASICON-type structure was used as a solid electrolyte; and a carbon powder was used as an electron-conductive material. Also, a carbon material was used as a collector layer material.

<fabrication of electrode green sheet, solid electrolyte green sheet>

A crystal powder of LVP as an electrode active substance material and polyvinyl alcohol as a binder were mixed to fabricate an electrode active substance slurry. The blending ratio was set to be LVP:polyvinyl alcohol=80:20 in mass ratio.

A glass powder of LAGP as a solid electrolyte material and polyvinyl alcohol as a binder were mixed to fabricate a solid electrolyte slurry. The mixing ratio was set to be LAGP:polyvinyl alcohol=80:20 in mass ratio.

A carbon powder as an electron-conductive material and polyvinyl alcohol as a binder were mixed to fabricate an electron-conductive material slurry. The mixing ratio was set to be carbon powder:polyvinyl alcohol=80:20 in mass ratio.

The electrode active substance slurry, the solid electrolyte slurry, and the electron-conductive material slurry fabricated in the above were mixed so that the mixing ratio of LVP, LAGP, and carbon powder would be LVP:LAGP:carbon powder=45:45:10 in mass ratio, so as to fabricate an electrode slurry.

The electrode slurry and the solid electrolyte slurry fabricated in the above-described manner were molded to a thickness of 50 μm by using a doctor blade, thereby to fabricate an electrode green sheet and a solid electrolyte green sheet.

<fabrication of collector green sheet>

A carbon powder as an electron-conductive material and polyvinyl alcohol as a binder were mixed to fabricate a collector slurry. The mixing ratio was set to be carbon powder:polyvinyl alcohol=70:30 in mass ratio.

The collector slurry fabricated in the above was molded to a thickness of 50 μm by using a doctor blade, thereby to fabricate a collector green sheet.

<fabrication of total solid battery>

A green sheet for a positive electrode layer 11 and a green sheet for a collector layer 14 that had been stamped out into a circular disk shape having a diameter of 12 mm were stacked onto one surface of a green sheet for a solid electrolyte layer 13 that had been stamped out into a circular disk shape having a diameter of 12 mm with a construction of a stacked body such as shown in FIG. 4, and were thermally press-bonded at a temperature of 80° C. under a pressure of 1 ton, thereby to fabricate 6 pieces of green sheet stacked bodies for forming a stacked body 101 that constitutes a part of a total solid battery.

Each of the 6 pieces of green sheet stacked bodies fabricated in the above was sandwiched between two sheets of ceramic plates made of alumina and fired at a temperature of 400° C. in a nitrogen gas atmosphere (first firing step). Thereafter, the 6 pieces of green sheet stacked bodies were each fired at a temperature of 450° C. in a nitrogen gas atmosphere containing 50 vol %, 20 vol %, 5 vol %, 1 vol %, 0.5 vol %, and 0.1 vol % of oxygen, respectively (second firing step). After the second firing step, each of the stacked bodies was fired at a temperature of 600° C. in a nitrogen gas atmosphere (third firing step), thereby to fabricate a stacked body 101 constituting a part of the total solid battery by bonding the collector layer 14, the positive electrode layer 11, and the solid electrolyte layer 13 by firing, as shown in FIG. 4. Here, the stacked body fired in a nitrogen gas atmosphere in which the oxygen content in the nitrogen gas atmosphere was 0.1 vol % in the second firing step could not be used for a total solid battery because sintering was inhibited.

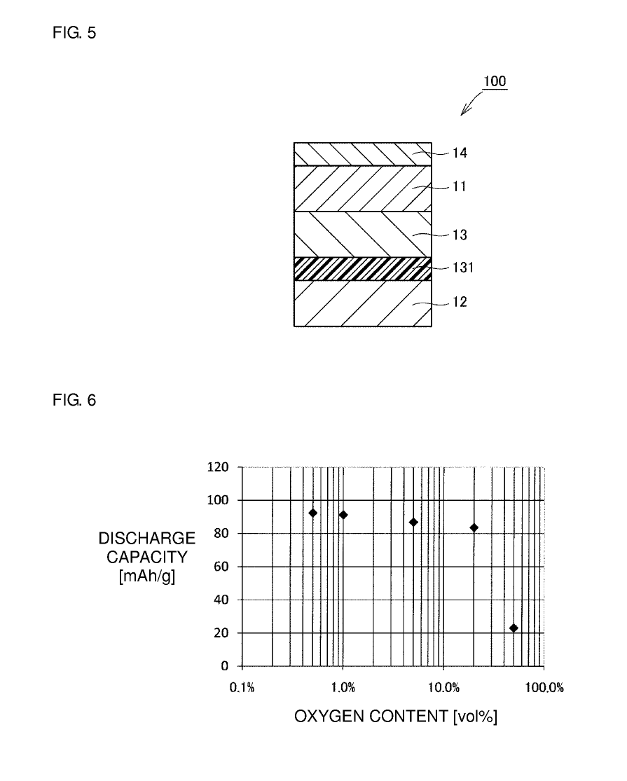

Among the obtained 6 pieces of green sheet stacked bodies, 5 pieces of stacked bodies fired in a nitrogen gas atmosphere in which the oxygen content in the nitrogen gas atmosphere was 0.5 vol % to 50 vol % in the second firing step were dried at a temperature of 100° C. to remove the moisture. Thereafter, as illustrated in FIG. 5, a polymethyl methacrylate (PMMA) gel electrolyte 131 was applied onto metal lithium serving as a negative electrode layer 12 (counter-electrode), and the negative electrode layer 12 was stacked so that the surface of the solid electrolyte layer 13 would be in contact with the PMMA gel electrolyte 131, thereby to fabricate a total solid battery stacked body 100. The total solid battery stacked body 100 was sealed with a coin cell of 2032 type to fabricate a total solid battery.

<evaluation of total solid battery>

A constant-current constant-voltage charging/discharging measurement of the total solid battery fabricated in the above was carried out in a voltage range of 3 to 4.5 V and at a current density of 20 μA/cm². As a result obtained by the measurement, FIG. 6 shows a relationship between the discharge capacity of the total solid battery and the oxygen content in the atmosphere in which the second firing step was carried out.

From FIG. 6, the discharge capacity showed 84 mAh/g when the oxygen content in the atmosphere in which the second firing step had been carried out was 20 vol %. Further, the discharge capacity showed a high discharge capacity of 90 mAh/g or more when the oxygen content in the atmosphere in which the second firing step had been carried out was within a range of 0.5 vol % to 5 vol %. Here, it was confirmed that the discharge capacity was low when the oxygen content in the atmosphere in which the second firing step had been carried out was 50 vol %.

It is to be considered that the embodiments and Examples disclosed herein are exemplifications in all respects and are not limitative. The scope of the present invention is shown not by the above embodiments and Examples but by the claims, and it is intended that all corrections and modifications equivalent to or within the scope of the claims are comprised therein.

According to the method of producing a total solid battery of the present invention, oxidation of the collector layer can be suppressed, and deterioration of the characteristics of a total solid battery, in particular the characteristics of a total solid secondary battery, can be prevented, so that the present invention is particularly useful for production of a total solid secondary battery.

DESCRIPTION OF REFERENCE SYMBOLS

10: total solid battery stacked body

11: positive electrode layer

12: negative electrode layer

13: solid electrolyte layer

14: collector layer

1. A method of producing a total solid battery, the method comprising:
forming a stacked body by stacking a molded body of each of a positive electrode material, a solid electrolyte material, a negative electrode material, and a collector material adjacent at least one of the positive electrode material and the negative electrode material; and
firing said stacked body,
wherein said firing includes:
a first firing step of firing said stacked body in an inert atmosphere; and
after the first firing step, a second firing step of firing said stacked body in an atmosphere containing oxygen.

2. The method of producing a total solid battery according to claim 1, wherein said first firing step includes heating said stacked body at a temperature of 600° C. or below.

3. The method of producing a total solid battery according to claim 2, wherein said temperature is at least 100° C.

4. The method of producing a total solid battery according to claim 2, wherein said second firing step includes heating said stacked body at a temperature of 200° C. to 700° C.

5. The method of producing a total solid battery according to claim 1, wherein said second firing step includes heating said stacked body at a temperature of 200° C. to 700° C.

6. The method of producing a total solid battery according to claim 1, wherein an oxygen content in the atmosphere containing oxygen is more than 0 vol % and 20 vol % or less.

7. The method of producing a total solid battery according to claim 6, wherein the oxygen content is 0.5 vol % or more and 5 vol % or less.

8. The method of producing a total solid battery according to claim 1, wherein said stacked body is formed by stacking a green sheet of each of the positive electrode material, the solid electrolyte material, the negative electrode material, and the collector material.

9. The method of producing a total solid battery according to claim 1, wherein at least one material among said positive electrode material, said solid electrolyte material, and said negative electrode material contains a solid electrolyte made of a lithium-containing phosphoric acid compound having a NASICON-type structure.

10. The method of producing a total solid battery according to claim 9, wherein at least one material among said positive electrode material and said negative electrode material contains an electrode active substance made of a lithium-containing phosphoric acid compound.

11. The method of producing a total solid battery according to claim 1, wherein at least one material among said positive electrode material and said negative electrode material contains an electrode active substance made of a lithium-containing phosphoric acid compound.

12. The method of producing a total solid battery according to claim 1, wherein
the positive electrode material contains a positive electrode active substance selected from the group consisting of a lithium-containing phosphoric acid compound having a NASICON-type structure, a lithium-containing phosphoric acid compound having an olivine-type structure, a lithium-containing layered compound, and a lithium-containing compound having a spinel-type structure; and
the negative electrode material contains a negative electrode active substance selected from the group consisting of a compound having a composition represented by MOₓ, a graphite-lithium compound, a lithium alloy, and a lithium oxide, wherein M is at least one element selected from the group consisting of Ti, Si, Sn, Cr, Fe, and Mo, and x is a numerical value within a range of 0.9≦x≦2.0.

13. The method of producing a total solid battery according to claim 1, wherein the collector material contains an electron-conductive material.

14. The method of producing a total solid battery according to claim 13, wherein the electron-conductive material contains at least one material selected from the group consisting of an electron-conductive oxide, a metal, and a carbon material.

15. The method of producing a total solid battery according to claim 1, wherein the collector material is adjacent the positive electrode material, the method further comprising applying a gel electrolyte between the negative electrode material and the solid electrolyte material.

16. A total solid battery produced by the method according to claim 1.
